(19) United States
(12) Patent Application Publication
(10) Pub. No.: US 2024/0382998 A1
(43) Pub. Date: Nov. 21, 2024

(54) Reusable and Interchangeable Custom Tip Compound Application Device

(71) Applicant: Planet Growth LLC, Recine, WI (US)

(72) Inventors: Conor S. Hammes, Racine, WI (US); Cody Zimmerman, Lakewood, CO (US); Charles Strickler, New Castle, PA (US)

(21) Appl. No.: 18/665,743

(22) Filed: May 16, 2024

Related U.S. Application Data
(60) Provisional application No. 63/467,065, filed on May 17, 2023.

(51) Int. Cl. B05C 17/005; B05C 17/01

(52) U.S. Cl. CPC B05C 17/00513; B05C 17/0123

(57) ABSTRACT

The present invention relates to a device designed to enhance the efficiency and environmental sustainability of applying various compounds used in construction and repair tasks. The device comprises a first connector end equipped with a set of threads, a customizable tip that is configured to be received by the first connector end, and a second connector end that features a cavity to securely receive the tip. The second connector end also includes a corresponding set of threads that engage with the threads of the first connector end to tighten the assembly, ensuring a robust and leak-proof connection. Additionally, the device includes a container of compound that attaches to the first connector end, allowing for a seamless and controlled flow of the compound through the device. This invention provides a versatile solution that accommodates a wide range of compound types and application needs, with the added benefit of being environmentally friendly by reducing waste associated with traditional single-use compound application systems. The device's interchangeable tips and reusable components not only promote sustainability but also offer users the flexibility to adapt the tool for various specific tasks, enhancing precision and efficiency in compound application.

### CROSS REFERENCE TO RELATED APPLICATIONS

This application claims the benefit of and priority to U.S. Provisional Patent Application 63/467,065, filed on May 17, 2023, which is hereby incorporated by reference in its entirety.

### BACKGROUND

Compound container packaging generally comes in plastic or cardboard tubes. This leads to over 200,000,000 empty plastic compound tubes being sent to landfills in the United States every year. This is a lot of waste. It is desirable that the components of the packaging for the compound industry become reusable, compostable, decomposable, and more environmentally friendly.

Traditional caulking tubes require that a user cut the tip of the caulking tube, but every user cuts them differently, and even a professional has difficulty cutting the tip in the same shape every time, or to the specific size needed for various jobs. In conventional tubes, once the tip has been cut, a long piece of thin metal is usually inserted into the opening of the tip. The thin piece of metal is used to poke through a wrapper that seals the compound from being exposed to air.

It is with these issues in mind, among others, that various aspects of the disclosure were conceived.

### SUMMARY

The present disclosure is directed to a reusable and interchangeable custom tip compound application device. Whether the compound itself is packaged into tubes, cartridges, bags, or another container type, once the package is emptied, the tube, cartridge, bag or other container type, can be discarded without harming the environment.

In one example, the device may include a first connector end having a first set of threads, a tip that is configured to be received by the first connector end, a second connector end having a cavity to receive the tip and tighten the device by connecting a second set of threads with the first set of threads, and a container of compound that is attached to the first connector end.

In another example, the device may include a base, a customizable tip that sits flush with the base, and a tightener having a cavity to receive the customizable tip and having a first set of threads that connects with a second set of threads on the base and holds the customizable tip in place.

In another example, the device may include a base, a customizable tip that has been molded to a tightener having a first set of threads that connects with a second set of threads on the base and holds the customizable tip in place.

In another example, a method includes placing a base to receive a tip, seating the tip in a center of the base, placing a second connector end over the tip and receiving the tip in a cavity of the second connector end, tightening a first set of threads of the second connector end that is received by a second set of threads in the base, and loosening the second connector end and removing the tip to clean the base, the tip, and the second connector end.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 depicts a reusable and interchangeable custom tip compound application device according to an example of the instant disclosure.

FIG. 2 depicts superior aspects of the reusable and interchangeable custom tip compound application device according to an example of the instant disclosure.

FIG. 3 depicts an exploded view of aspects of the reusable and interchangeable custom tip compound application device according to an example of the instant disclosure.

FIG. 4 depicts an exemplary embodiment of a tip in accordance with the reusable and interchangeable custom tip compound application device according to an example of the instant disclosure.

FIG. 5 depicts an exemplary embodiment of a tip in accordance with the reusable and interchangeable custom tip compound application device according to an example of the instant disclosure.

FIG. 6 depicts an exemplary embodiment of a tip in accordance with the reusable and interchangeable custom tip compound application device according to an example of the instant disclosure.

FIG. 7 depicts an exploded view of superior aspects of the reusable and interchangeable custom tip compound application device according to an example of the instant disclosure.

FIG. 8 depicts an exploded view of aspects of the reusable and interchangeable custom tip compound application device to a tube or container of compound according to an example of the instant disclosure.

FIG. 9 depicts a semi-exploded view of aspects of the reusable and interchangeable custom tip compound application device to a tube or container of compound according to an example of the instant disclosure arranged in accordance with an exemplary method of use.

FIG. 10 depicts a semi-exploded view of aspects of the reusable and interchangeable custom tip compound application device to a tube or container of compound according to an example of the instant disclosure arranged in accordance with an exemplary method of use.

FIG. 11 depicts a semi-exploded view of aspects of the reusable and interchangeable custom tip compound application device to a tube or container of compound according to an example of the instant disclosure arranged in accordance with an exemplary method of use.

FIG. 12 depicts a semi-exploded view of aspects of the reusable and interchangeable custom tip compound application device to a tube or container of compound according to an example of the instant disclosure arranged in accordance with an exemplary method of use.

FIG. 13 depicts an exemplary method of use according to an embodiment.

### DETAILED DESCRIPTION

The present disclosure is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present disclosure, as the disclosure encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

A reusable interchangeable custom tip compound application device in the preferred embodiment includes a first attachment end or base and a second attachment end. The first attachment end, also referred to as the base, is designed to interface directly with a container or tube of compound, ensuring a secure and stable connection. This base and container can connect in any number of ways in accordance with teachings of the invention. In various exemplary embodiments, the connection may be effectuated by being glued together directly or through a 3rd material type, through being form fitted to slide together, through being melted together, through being forged together, through being molded together, through being casted together, and through being equipped with a set of external threads that facilitate attachment to the container, which may contain any type of compound such as silicone, grout, grease or mortar.

The device in an embodiment also features a reusable tip that is designed to sit flush with the first attachment end. This tip is configured for directing the flow of the compound and can be customized to suit different application needs, such as varying bead sizes or shapes. The tip is made from a durable material that can withstand repeated use and cleaning, making it both economical and environmentally friendly. The first attachment end, the tip and the second connector end can also be made from biodegradable materials, allowing for single use applications where all of the elements of the invention including the compound container can be disposed of in an environmentally friendly way.

The second attachment end of the device in an embodiment includes a cavity that is specifically shaped to receive the reusable tip. This cavity aligns the tip precisely with the base, ensuring that the compound flows smoothly and consistently. The second attachment end also contains one or more internal or external threads that correspond to the external or internal threads on the first attachment end. By screwing the second attachment end onto the base, the reusable tip is securely held in place between the two ends. This threaded connection not only provides a firm hold but also allows for easy disassembly of the device for cleaning or tip replacement.

In another embodiment, the second attachment end of the device has internal or external threads that are molded to the base of the custom shaped tip. The contour and shape, specifically the depth of the cavity in the first attachment end or base allows the internal or external threads and the base of the second attachment end to sit down inside of and connect flushly with the base of the first attachment end. The second attachment end and the base of the tip are then held in place by the resistance of an opening in a manual or automated caulking dispenser.

Furthermore, the design of the base allows it to be attached to various types of compound containers, cartridges, bags or tubes. This versatility ensures that the device can be used in a wide range of applications, from simple household repairs to professional construction projects that may be powered by artificial intelligence, robots and computer networks. The ability to attach directly to the compound container minimizes waste and enhances the ease of use, as it eliminates the need to use one's hands, latex gloves, a cloth, a separate tool, or any other method to apply the compound.

In one example, a reusable and interchangeable compound application device may include several key components: a reusable base, a reusable custom tip, and a reusable tightener. Each of these components is designed to enhance the functionality and sustainability of the device in accordance with an embodiment.

The reusable base 102 serves as the foundation of the device 100 in accordance with an embodiment. In an embodiment, it is constructed from a durable material such as high-grade plastic, plastics additives, epoxy, resin, liquid wood, bioplastic, biopolymer, pcl polyesters, aromatic polyesters, polyesters, polyethylene terephthalate (PET), polycaprolactone (PCL), PHA Polyesters, Starch-Based Polymers, plant-based additives, or metal to ensure longevity and resistance to wear. The base 102 is designed to attach directly to a container, cartridge, bag or tube of compound, facilitating a seamless transfer of the compound through the device 100. This base 102 may feature a series of external or internal threads or other mechanical means to securely connect to the compound container and to interface with the reusable tightener.

In accordance with varying embodiments, the term “compound” refers to any viscous or semi-viscous material used in construction, maintenance, or repair tasks that requires precise application. This includes a wide range of substances that can be applied using the device to seal, bond, or fill gaps and joints in various construction and home improvement projects. Examples of compounds that can be used with this device include caulk, acrylic latex, vinyl latex, acrylic tile sealant, siliconized acrylic sealant, adhesive caulk, butyl rubber, asphalt, fireproof caulk, and Polyurethane, among any of the other 200+ types of compounds known today, and those yet to be discovered by the world. One example is silicone, which is often used for sealing in wet areas like bathrooms and kitchens due to its waterproof properties. Another example is grout, commonly used to fill the spaces between tiles. Mortar, which is used for bonding bricks and stones, is another type of compound suitable for this device. Additionally, joint compound is used in drywall installation to smooth over seams and cover nail and screw indentations. Each of these compounds has specific properties that make them ideal for particular tasks, and the device is designed to handle the application of these diverse materials efficiently and with minimal waste. The ability to interchange custom tips allows for the precise application of each type of compound according to its consistency and the specific requirements of the job.

Adjacent to the base 102 is the reusable custom tip 104, which in an embodiment controls the application of the compound. This tip 104 sits flush against the base 102, creating a tight seal that prevents leaks and ensures precise application. The custom tip 104 in varying embodiments is configured in various shapes and sizes, depending on the specific requirements of the job, such as different bead widths or complex geometric patterns. Made from materials that can be easily cleaned and reused, or discarded in a biodegradeable manner, in an embodiment the tip supports environmental sustainability by reducing waste and residues.

The reusable tightener in accordance with an embodiment secures the custom tip 104 to the base 102. In an embodiment, it comprises internal or external threads that correspond to the external or internal threads on the base 102, allowing it to be screwed on securely. The tightener may also have a cavity or a specific contoured shape that matches the shape of the custom tip 104, allowing the base of the reusable tightener 106 to act as a stabilizer, ensuring that the tip 104 is held firmly in place during use, especially where force is applied against or to the sides or the end of the tip. This design not only stabilizes the tip 104 but also allows for quick and easy adjustments or replacements of the tip as needed.

Together, these components form a cohesive unit that provides a reliable and efficient means of applying various compounds. The device's 100 interchangeable nature in such embodiment allows for flexibility in use, as different tips can be swapped in and out easily, catering to a wide range of application needs. This not only enhances the utility of the device 100 but also promotes reuse, aligning with environmental conservation efforts by minimizing disposable waste and residues.

As an example, the reusable tightener can be spun inside or outside of one or more threads in the reusable base. As a result, a reusable custom tip can be held in place at the base. A second reusable custom tip with a different shape can be used for a specific job and interchanged with the reusable base before, during, or after the project. The reusable custom tip can be removed from the reusable base and washed. The reusable custom tip can also be discarded in an environmentally friendly manner. As an example, an environmentally friendly tube, cartridge, bag, or other container of compound can be attached to the reusable base.

In accordance with varying embodiments, the term “container of compound” refers to any receptacle that holds the compound material to be applied using the device 100. This container is designed to attach securely to the first connector end of the device 100, ensuring a seamless flow of the compound into the device 100 for application. The versatility of the device 100 allows it to accommodate various types of containers, ranging from traditional tubes and cartridges commonly used for caulks and sealants, to more unorthodox examples such as refillable eco-friendly bags or even biodegradable capsules that contain adhesives or other compounds.

For instance, in a conventional setting and in accordance with an embodiment, a standard silicone sealant tube might be used as the container. However, in more innovative applications and in accordance with an alternative embodiment, a contractor might use a specially designed, reusable aluminum cartridge that can be refilled from a bulk dispenser of sealant, or a contractor or homeowner may dispense a one time use pre-filled biodegradeable foil bag, significantly reducing plastic waste. Another example could be a biodegradable paper-based bag filled with grout for tile work, emphasizing sustainability. Another exemplary embodiment comprises a plant-based cartridge with a thin internal foil wrapper that contains compound. Another exemplary embodiment comprises a plastic cartridge with a thin internal foil wrapper that contains compound. These containers are designed to be form fitted, glued, melted together, or connected with features such as threads or a coupling mechanism that matches the device's connector end, ensuring they can be easily and securely attached and possibly detached. This adaptability allows users to choose the most appropriate type of compound and container based on the specific requirements of their project, whether they prioritize durability, adhesion properties, ease of use, cost efficiency, or environmental impact.

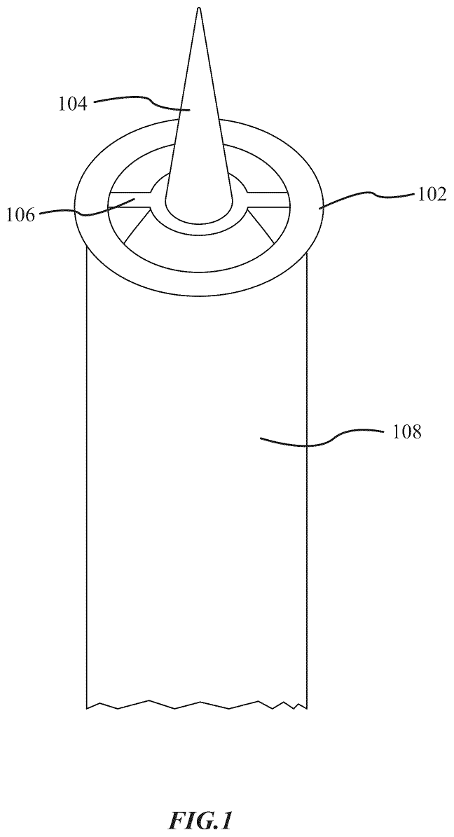

FIG. 1 depicts a reusable and interchangeable custom tip compound application device 100 according to an example of the instant disclosure.

The reusable and interchangeable compound tip application device 100 may have multiple styles of tips for any compound type. There are over two hundred compounds in the world and the device 100 can be used with any compound. As an example, the device 100 can be used with any silicone, grout, mortar, grease or joint compound.

As shown in FIG. 1, the reusable and interchangeable compound tip application device 100 in its preferred embodiment comprises a base 102 or first attachment end that may have a set of screw threads, a tip 104, and a second attachment end 106 having a second set of screw threads that is configured to attach to the base 102 and hold the tip 104 therebetween. The base 102 may attach to a tube or container of compound 108. In one example, the base 102 and the second attachment end 106 frictionally connect or fit with one another. In one example, the first connector end 102 comprises a base of the device. In another example, the second connector end 106 comprises a top of the device. As another example, the tip 104 comprises a middle layer held flush between the first connector end 102 and the second connector end 106 when the second connector end is tightened into the first connector end.

In one example, the device 100 may include a first connector end 102 having a first set of threads, a tip 104 that is configured to be received by the first connector end, a second connector end 106 having a cavity to receive the tip 104 and tighten the device by connecting a second set of threads with the first set of threads, and a container of compound 108 that is attached to the first connector end 102.

In an exemplary embodiment, the device 100 comprises a first connector end 102 having a first set of threads, a tip 104 that is configured to be received by the first connector end, a second connector end 106 that is molded to the exterior or interior sidewalls of a cavity in the center base of tip 104. In accordance with a preferred method of use, the device 100 is tightened by connecting the second set of threads with the first set of threads. In accordance with such embodiment, a container of compound 108 is attached to the first connector end 102.

The first connector end 102, in the preferred embodiment forming part of the base of the device, is equipped with a set of threads designed to engage compatibly with a corresponding set of threads on the second connector end 106 or the tightener in an example. This threaded connection is important for securely attaching the two ends in accordance with an embodiment, ensuring that the device 100 remains intact and functional during the application of the compound. The threads allow for easy assembly and disassembly, facilitating maintenance, cleaning, and the interchangeability of tips for different application needs. For instance, a user might switch from a fine-threaded or smaller radius tip for detailed, precision work, such as sealing small gaps around window frames, to a coarser-threaded or larger radius tip for applying a thicker bead of adhesive needed for larger joints in construction panels. These varying threaded geometrical designs not only enhance the versatility of the device but also ensures a robust connection that can withstand the pressures of compound application without leakage or failure, thereby supporting consistent and reliable performance across a variety of tasks.

In accordance with the preferred embodiment, the device 100 comprises a tip 104 configured to be received by the first connector end 102. This design feature involves the tip 104, which is specifically shaped and sized to fit securely into the first connector end 102, part of the base 102. The configuration of the tip ensures that it aligns perfectly with the connector, facilitating a seamless connection that is essential for the effective functioning of the device 100. This connection is important in accordance with the embodiment because it directly influences the precision and control over the application of the compound. For example, if the device 100 is being used to apply silicone sealant around a bathtub, the tip must fit snugly and securely into the first connector end to prevent any leakage or uneven application of the silicone. The tip's 104 design allows for easy insertion and removal, enabling quick changes between different types of tips for various application needs, such as switching from a narrow tip for fine bead applications to a broader tip for filling larger gaps. This feature not only enhances the device's versatility but also ensures that each application of compound is executed with the highest level of accuracy and efficiency, tailored to the specific requirements of the task at hand.

In another example, the device 100 may include a base 102, a customizable tip 104 that sits flush with the base, and a second connector end (alternatively characterized as a tightener in an embodiment) 106 having a cavity to receive the customizable tip 104 and having a first set of threads that connects with a second set of threads on the base 102 and holds the customizable tip 104 in place. The base 102 may be fastened to the fastener 106 to hold the tip 104 therebetween using the threads or another fastening mechanism or device. As an example, the first set of threads sit inside of the second set of threads. In one exemplary embodiment, the first set of threads sits outside of the second set of threads. In one example, a user may fasten the base 102 to the fastener 106 by using clockwise rotational motion to fasten the first set of threads with the second set of threads. The base 102 may be unfastened from the fastener 106 using counterclockwise rotational motion.

The device 100 may further include the container of compound 108 attached to the base 102. As another example, the base 102, the customizable tip 104, and the tightener 106 are plastic. In another example, the base 102, the customizable tip 104, and the tightener 106 are metal. In another example, the base 102, the customizable tip 104, and the tightener 106 are plant based. In another example, the customizable tip 104 is configured to create a bead of compound having a particular size and shape.

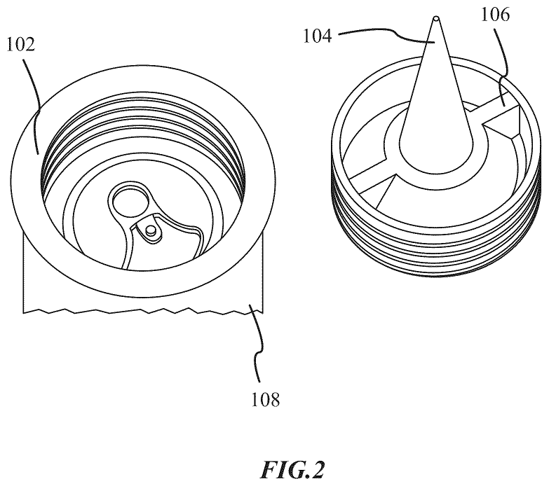

FIG. 2 depicts the reusable and interchangeable custom tip compound application device 100 according to an example of the instant disclosure. FIG. 2 illustrates how one side of the device 100 can unscrew to swap out the tip 104, allowing the end user to select an appropriate style custom job tip to allow the compound material to exit the device 100 with a specific geometric shaped bead of compound. For water soluble compounds, the components of the device 100 including the tip 104 can be separated, and can be immersed in water to allow a user to clean components of the device 100. For non-water soluble compounds, the components of the device 100 including the tip 104 can be separated, and can be immersed in a solvent to allow a user to clean components of the device 100.

Thus, as an example, the reusable and interchangeable custom tip compound application device 100 may be reusable or disposable in accordance with an embodiment.

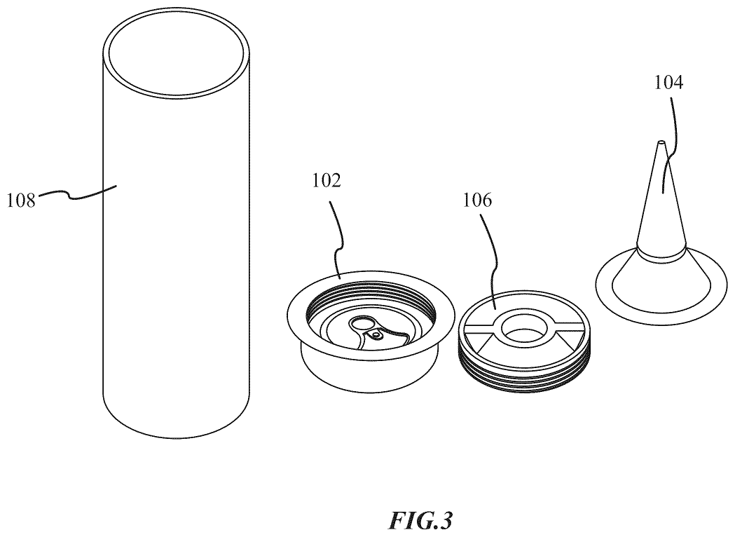

FIG. 3 depicts the reusable and interchangeable custom tip compound application device 100 according to an example of the present disclosure. FIG. 3 shows an example of pre-molded custom tips having various shapes. The base 102 of the device 100 in an exemplary embodiment is connected to any style container contemplated for holding compound. Examples of such containers contemplated for use in accordance with embodiments include but are not limited to a 2″ wide compound tube, a foil bag, a cartridge, a cartridge lined with foil, or any different compound container as commonly understood in the art. Embodiments enable the use of any compound container package to be utilized in accordance with the invention. Such packages include but are not limited to a tube, a cartridge, plastic, cardboard, a foil bag, or any other type of packaging. The package can be connected with the device 100 and unsealed to expose the contents the air. In accordance with one exemplary embodiment, the packaging contemplated for utilization may comprise a pull tab to be unsealed. In accordance with other exemplary embodiments, other formats and unsealing mechanisms are possible, including poking a hole in the cartridge.

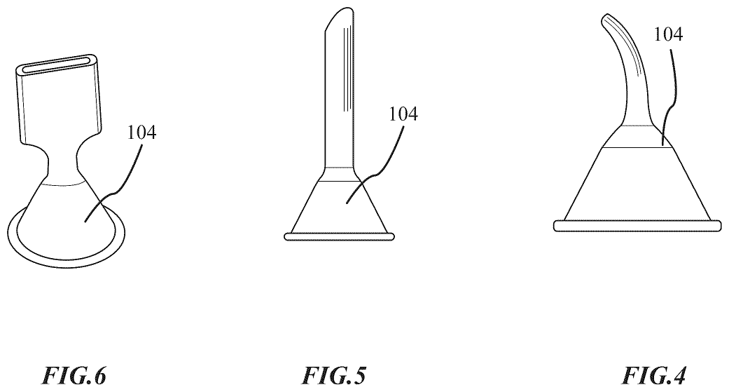

FIG. 4 depicts the reusable and interchangeable custom tip compound application device 100 according to an example of the instant disclosure. As shown in FIG. 4, any number combination of geometric style of tips can be used with the reusable and interchangeable compound tip application device 100. FIG. 4 shows a custom tip example.

FIG. 5 depicts the reusable and interchangeable custom tip compound application device 100 according to an example of the instant disclosure. As shown in FIG. 5, any combination of geometric style of tips are contemplated for utilization in accordance with the reusable and interchangeable compound tip application device 100. FIG. 5 depicts a custom tip example in accordance with an exemplary embodiment.

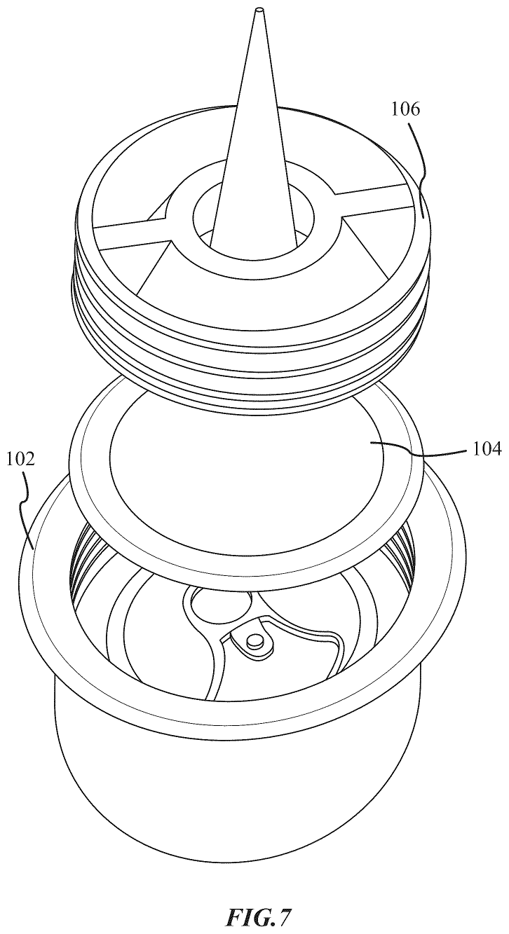

FIG. 6 depicts the reusable and interchangeable custom tip compound application device 100 according to an example of the instant disclosure. As shown in FIG. 6, any combination of geometric style of tips are contemplated for utilization with the reusable and interchangeable compound tip application device 100. FIG. 6 depicts a custom tip example in accordance with an exemplary embodiment.

In one example, each tip 104 allows a user to more easily create a bead of compound and create the bead that may be desired as needed for a specific job. The design of the reusable and interchangeable custom tip in the compound application device significantly enhances the ease and precision with which a user can apply a bead of compound. Each tip 104 in accordance with exemplary embodiments is specifically engineered to sit flush with the base of the device 100, ensuring a seamless flow of compound without leaks or interruptions. This flush alignment is crucial for maintaining consistent pressure and flow rate, which are essential for the formation of a smooth, uniform bead of compound. Each tip 104 can be customized in shape and size to match the specific requirements of various tasks, such as filling narrow cracks or creating wider seals. For instance, a narrower tip might be used for precision work on fine cracks, while a broader tip could be employed for filling larger gaps or laying down a thick bead of compound for sealing purposes. The ability to quickly interchange these tips according to the job at hand not only saves time but also reduces the need for manual adjustments or the use of multiple tools, thereby increasing efficiency and improving the quality of the work. This feature is particularly beneficial in professional settings where time and accuracy are critical, allowing users to adapt swiftly to different project requirements without compromising on the quality of the application.

As an example, for finishing over an indented screw head on a piece of drywall, a built in custom spatula shaped custom tip can help ensure the drywall finishing compound is forced into the various size hole depths that occur during the drywall hanging and screwing process, where the custom spatula shaped tip smooths out the finishing compound for a flat finish. This can remove the need to use one's fingers, a cloth, a separate tool, or another method to apply the compound bead and form it into the shape required for the specific job. As a result, the end user can keep both hands on the caulking gun and apply and smooth out the compound bead using custom shaped tips with the device 100.

Other custom interchangeable tips may include shapes and sizes to apply compound for specific jobs such as grout for tile as well as for filling various widths created by various standard tile spacers. As a result, the device 100 is able to create specific sized beads of compound using different custom tips that may be designed or configured for tile. Other job specific tips may be associated with installing windows, doors, counter tops, siding, flooring, working with wood, cement fiber board, steel, and grease, among others.

FIG. 7 depicts the reusable and interchangeable custom tip compound application device 100 according to an example of the instant disclosure. As shown in FIG. 5, the second attachment end 106 fits on top of the tip 104. The tip 104 and the second attachment end 106 fit into the base 102.

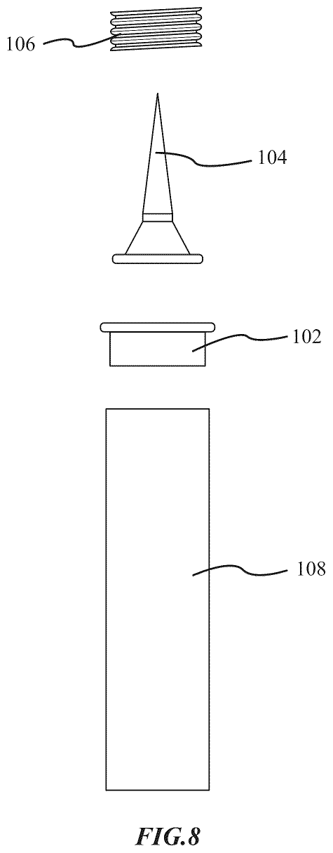

FIG. 8 depicts the reusable and interchangeable custom tip compound application device 100 according to an example of the instant disclosure. FIG. 8 shows an isometric view of the device 100. As shown in FIG. 8, the base 102 is connected to the tube 108. The second attachment end 106 is fastened, screwed into, or attached to the base 102 and the tip 104 fits in a cavity of the second attachment end 106.

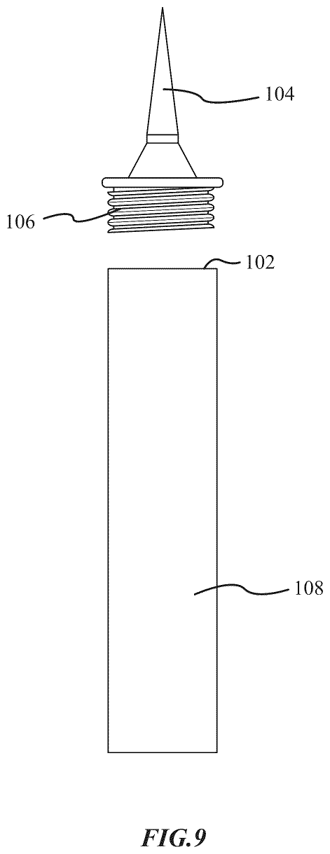

FIG. 9 depicts the reusable and interchangeable custom tip compound application device 100 according to an example of the instant disclosure. As shown in FIG. 9, the second attachment end 106 is fully screwed into and tightened into the base 102. The top layer above the second attachment device 106 comprises the tip 104 in accordance with an embodiment.

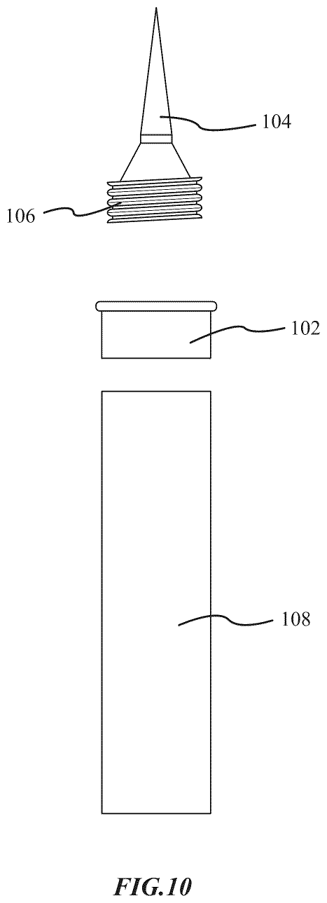

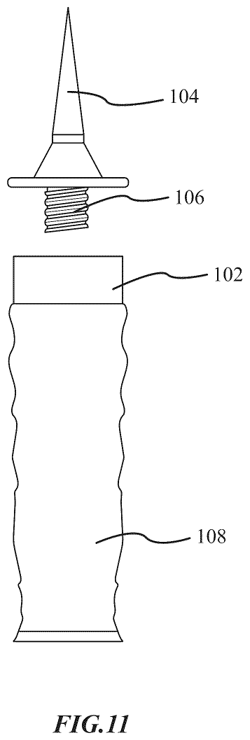

FIG. 10 depicts the components of the reusable and interchangeable custom tip compound application device 100 according to an example of the instant disclosure. As shown in FIG. 10, the device 100 includes the base 102 that connects or attaches to the second attachment end 106. The tip 104 is attached or molded as a top layer to the second attachment end 106. The second attachment end 106 has an aperture, hole, or cavity to allow the compound to flow between the first attachment end or base 102 and the tip 104. In one example, the thicker-coarse threaded cavity in the first attachment end or base 102 is in a center or middle of the first attachment end 106 and the cavity may be circular in shape. The aperture, hole, or cavity in the second attachment end 106 is configured to precisely accommodate the shape and dimensions of the first attachment end or base 102 in accordance with varying embodiments. This ensures a snug fit, which is important in accordance with the preferred embodiment for several reasons. Firstly, the precise fit helps to stabilize the tip 104 when the device is in use, preventing any wobbling or misalignment that could affect the application of the compound. Secondly, it ensures that there is a seamless transition for the compound flowing through the tip 104, which is critical for achieving a consistent and controlled output. This is particularly important when precision is required in the application, such as in sealing or in detailed adhesive work. Moreover, the design of the cavity in the second attachment end 106 facilitates a secure connection when it is tightened onto the base 102. This connection not only holds the tip 104 firmly in place but also ensures that there are no gaps or loose fittings that could lead to leaks or drips, thereby maintaining the integrity and efficiency of the compound application process. This feature in accordance with an embodiment underscores the device's capability to provide reliable and precise performance in various compound application scenarios.

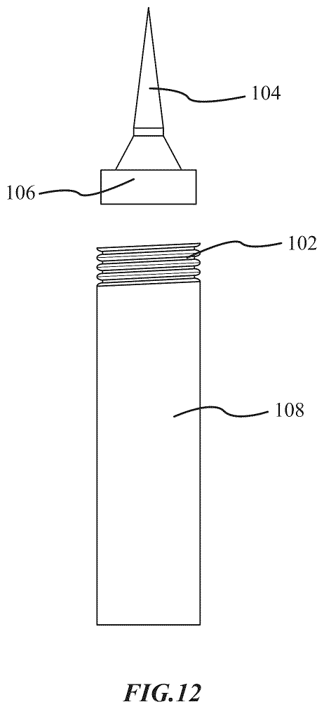

FIG. 11 depicts the components of the reusable and interchangeable custom tip compound application device 100 according to an example of the instant disclosure. As shown in FIG. 11, the tip 104 is connected to a second attachment end 106. The second attachment end 106 is then connected to the the first attachment end or base 102 through a finer-threaded thinner geometrically shaped connection in accordance with an exemplary embodiment. The first attachment end or base 102 is connected to a container 108. The first attachment end or base 102 can have a cavity that allows the second attachment end 106 to sit inside of the first attachment end or base 102, making room for the base of tip 104 to sit inside of and behind the end of the dispensing device in accordance with an exemplary embodiment. The second attachment end 106 is configured to sit flush with the top of the first attachment end or base 102 in accordance with an alternative embodiment.

FIG. 12 depicts the reusable and interchangeable custom tip compound application device 100 according to an example of the instant disclosure. As shown in FIG. 12, in an exemplary embodiment, the second attachment end 102 is molded into or connected to the top of tube or container 108. The first attachment end or base 106 is molded or connected to the tip 104 in accordance with an exemplary embodiment. The second attachment end 102 can be attached to the first attachment end 106 or the first attachment end 106 can be attached to the second attachment end 102 in accordance with such exemplary embodiments.

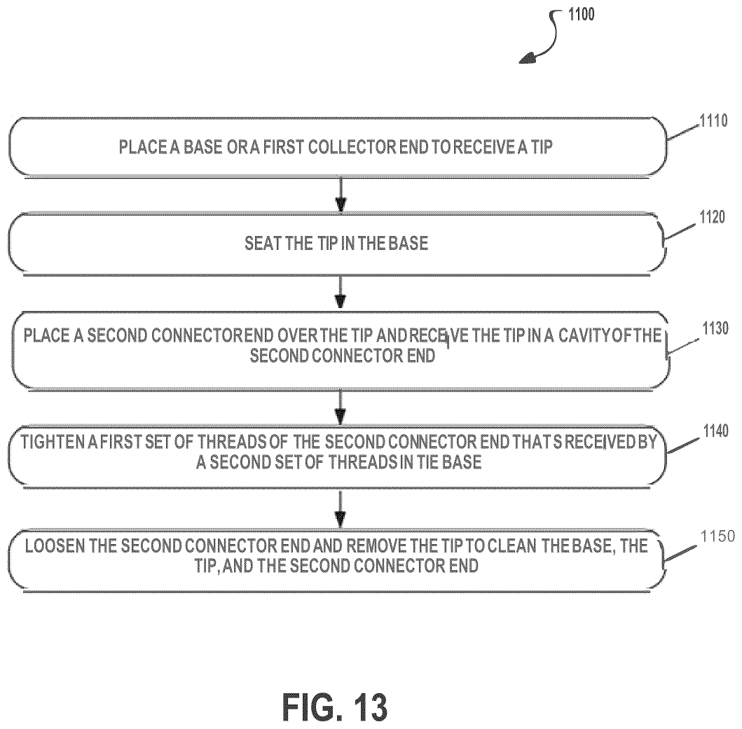

FIG. 13 illustrates an example method 1100 of attaching the device 100 to a tube or container of compound 108 according to an example of the instant disclosure. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some examples, the method 1100 includes placing a base or a first connector end 102 to receive a tip 104 at block 1110. This step involves preparing the base, which serves as the primary attachment point for the compound container and the foundational support for the tip. The base is designed with a specific configuration, often featuring a set of threads or a locking mechanism, to securely accommodate the tip. When placing the base or first connector end 102 to receive a tip 104, the user aligns the tip 104 with the base or first connector end 102, ensuring that it fits snugly and precisely. This alignment is critical as it affects the subsequent flow and application of the compound. The base's 102 design may include a recessed area or a specific contour that matches the shape of the tip 104, which helps in stabilizing the tip 104 and preventing any rotational or lateral movement during use. This secure attachment is essential for maintaining the integrity of the seal between the tip 104 and the base or first connector end 102, thereby ensuring that the compound is delivered smoothly and consistently without any leakage or variation in the bead size. This step sets the stage for a reliable and efficient compound application process, tailored to the specific needs of the job at hand.

According to some examples, the method 1100 includes seating the tip 104 in the base 102 at block 1120. This step involves precisely positioning the tip 104 within a designated area or cavity of the base 102, which is typically configured to match the shape and size of the tip 104. Proper seating of the tip 104 is essential for creating a tight and secure connection between the tip and the base, which is crucial for preventing any compound leakage and for maintaining consistent pressure during the application process. The design of the base 102 often includes features such as grooves or threads that align with corresponding features on the tip 104, facilitating a snug fit. This alignment is not only important for the physical stability of the tip 104 but also for ensuring that the compound flows directly through the tip 104 without any obstruction. Once the tip 104 is correctly seated, it remains flush with the base 102, providing a smooth transition point for the compound to exit the device. This precise seating enables users to apply a consistent bead of compound, tailored to the specific requirements of the task, whether it involves sealing, filling, or bonding materials.

According to some examples, the method 1100 includes placing a second connector end 106 over the tip 104 to be received in a cavity of the second connector end 106 at block 1130. This step involves aligning and inserting the tip 104 into a specially designed cavity within the second connector end 106. The cavity is crafted to precisely accommodate the shape and dimensions of the tip 104, ensuring a snug and secure fit. This precise alignment is crucial for several reasons: it stabilizes the tip 104 within the device, prevents the compound from bypassing the tip 104 and causing leaks, and ensures that the compound is directed through the tip in a controlled and uniform manner. The second connector end 106 in varying embodiments features internal threading or another form of mechanical fastener that mates with corresponding features on the base or the first connector end. When the second connector end is placed over the tip 104, it not only houses the tip 104 securely but also begins the process of creating a sealed environment necessary for the effective application of the compound. This step is important in accordance with various embodiments for maintaining the integrity of the application process, ensuring that the compound is applied with precision and consistency, adhering to the specific requirements of the task at hand. The present inventor has recognized that proper execution of this step results in a robust assembly that can handle the pressures of compound application without failure or degradation of performance.

This second connector end 106, which may alternatively be referred to as the tightener, is designed with an internal cavity in an embodiment that precisely accommodates the tip 104. This cavity is crucial as it aligns the tip correctly within the device, ensuring that the compound flows uniformly and is applied consistently. The cavity's design is such that it not only houses the tip but also supports it against the pressures exerted during the application of the compound, preventing any misalignment or movement that could disrupt the application process.

In an embodiment, it is therefore an aspect of the second connector end 106 to comprise a cavity to receive the tip and tighten the device 100 by connecting a second set of threads with the first set of threads. Moreover, the second connector end 106 in an exemplary embodiment features a set of threads that are designed to mate with the corresponding threads on the first connector end 102 (the base). This threaded connection allows these two parts of the device 100 to be securely fastened together by twisting them into place. The action of tightening these threads pulls the second connector end 106 towards the first connector end 102, reducing any gaps and securing the tip firmly between them. This mechanism ensures a tight seal, which is essential for preventing leaks and ensuring that the compound is directed through the tip with precision. For example, when applying grout between tiles, the secure and tight connection between the connector ends ensures that the grout is applied smoothly and consistently, without any backflow or spillage that could compromise the finish. The present inventor recognizes that this aspect of the device 100 not only facilitates ease of use and maintenance but also enhances the device's 100 reliability and effectiveness in various compound application tasks.

According to some examples, the method 1100 includes tightening a first set of threads of the second connector end 106 that is received by a second set of threads in the base 102 at block 1140. In another example, the second connector end 106 can be attached or fastened to the base 102 using an attachment device such as a fastener. This tightening process involves rotating the second connector end 106, which has a first set of threads, onto the base 102, which features a corresponding second set of threads. The interaction between these threads is designed to draw the second connector end 106 closer to the base 102, compressing the tip 104 securely between them. This action not only ensures that the tip 104 is held firmly in place, preventing any movement during use, but also creates a seal that prevents the compound from leaking at the junction points. In some instances, as an alternative or in addition to the threading mechanism, the second connector end 106 can be attached or fastened to the base 102 using an attachment device such as a fastener. This could include clips, bolts, or other mechanical fasteners that provide additional security and stability to the connection. This dual approach of threading combined with mechanical fasteners ensures a robust assembly that can withstand the pressures and stresses of compound application, providing a reliable and consistent performance throughout the lifespan of the device. In accordance with varying embodiments, securing the assembly is important for achieving precise and controlled application of compounds in various industrial and construction settings.

According to some examples, the method 1100 includes loosening the second connector end 106 and removing the tip 104 to clean the base 102, the tip 104, and the second connector end 106 at block 1150. The present inventor has recognized that this step provides an important maintenance procedure for the reusable and interchangeable custom tip compound application device in accordance with varying embodiments. This step in an example involves the user manually loosening the second connector end 106, which typically involves unscrewing or unfastening it from the base 102. This action reverses the tightening process, gradually disengaging the threads or other fastening mechanisms that hold the second connector end in place. Once loosened sufficiently, the second connector end 106 can be removed, exposing the tip 104. With the second connector end 106 detached, the tip 104 can then be easily extracted from its seated position within the base 102. This disassembly allows each component—the base 102, the tip 104, and the second connector end 106—to be individually accessed for thorough cleaning. Cleaning these components is essential for removing any residual compound, which the present inventor has observed can harden and potentially interfere with the function of the device. It also prevents the buildup of debris that could compromise the sealing and bonding capabilities of the compound application in future uses. Proper cleaning and maintenance of these components ensure the longevity and reliability of the device, maintaining its precision in compound application across various tasks in accordance with varying embodiments.

According to some examples, the method 1100 includes attaching the base 102 to a container of compound 108. A user may use the device 100 to supply the compound and perform a job such as a construction project or construction job. This connection is fundamental for the functionality of the device in its preferred embodiment as it allows the compound within the container to be accessed and utilized through the device 100. The base 102 is designed to interface seamlessly with the container of compound 108, which may come in various forms such as tubes, cartridges, or bags in accordance with varying embodiments. This attachment is typically achieved through a compatible fitting, fastening, gluing, molding, casting or threading mechanism that securely joins the base 102 to the container of compound 108, ensuring a tight seal that prevents leaks and maintains the integrity of the compound. Once the base 102 is securely attached to the container of compound 108, the device 100 is ready to be used to supply the compound for various applications. This could include tasks in construction projects where precise application of sealants, adhesives, or other compounds is required. The user can then manipulate the device 100 in accordance with an embodiment to apply the compound in a controlled and precise manner, suitable for the specific requirements of the job at hand. This might involve sealing joints, filling gaps, or applying adhesives in a way that ensures durability and adherence to building standards. The ability to attach the device 100 directly to the compound container simplifies the preparation process, enhances efficiency, and reduces waste, making it an useful tool in association with construction and other industrial applications.

According to some examples, the method 1100 includes applying the compound by creating a bead of compound having a particular size and shape that exits from the tip 104. This step involves the precise delivery of the compound through the tip 104, which has been specifically designed to shape the output according to the requirements of the task. The tip 104 can be customized or selected based on the desired size and shape of the bead of compound needed for a particular application, such as sealing, filling, or adhering materials.

In accordance with varying embodiments, the term “bead” may refer to to the continuous line or strip of compound material that is extruded through the device's tip 104 when the compound is applied to a surface. The size and shape of the bead are critical for ensuring that the right amount of compound is delivered for specific tasks, and these characteristics are determined by the design of the customizable tip 104. For example, a narrower tip might be used to create a thin bead for sealing fine cracks or joints, whereas a wider tip could be used to lay a thicker bead suitable for filling larger gaps or for applications requiring more substantial coverage, such as in laying a bead of caulk along the edge of a bathtub. The ability to control the bead's characteristics is essential for precision in tasks like waterproofing, insulating, or adhering materials in accordance with intended uses of an embodiment of the invention, where the effectiveness of the job can depend significantly on the accuracy of the compound application. This precise control helps ensure that the compound performs its intended function effectively, providing a seal or bond that meets the technical and aesthetic requirements of the project.

The ability to control the size and shape of the bead is essential for ensuring that the right amount of compound is applied efficiently and effectively. This precision helps in achieving a clean, professional finish, whether the compound is being used for sealing gaps around windows and doors, laying a bead of caulk along a bathroom fixture, or applying adhesive in a construction setting. The design of the tip 104 facilitates this by providing a structured path for the compound to follow, which helps maintain consistency in the application, reducing the likelihood of errors and rework. This step not only enhances the functionality of the device but also contributes to the overall quality of the workmanship in projects where precise application of compounds is crucial. By enabling the user to create a bead of compound with specific characteristics, the device 100 ensures that materials are used economically and effectively, contributing to both cost efficiency and high-quality results in various construction and repair tasks.

In accordance with a contemplated method of utilization associated with an embodiment of the invention, as summarized in FIG. 13, the following steps are performed.

Placing a Base or a First Connector End to Receive a Tip 1110: This initial step involves preparing the device for assembly by positioning the base 102, which is the first connector end equipped with external threads. The base 102 serves as the primary attachment point for both the compound container and the tip 104. It is designed to securely hold the tip 104 in place, which is crucial for the precise application of the compound. The user must ensure that the base 102 is oriented correctly to receive the tip 104, aligning any grooves or notches that facilitate a secure fit.

Seating the Tip in the Base 1120: Once the base is in place, the next step is to insert the tip 104 into the designated area on the base 102. The tip 104, which can be chosen based on the specific application requirements (e.g., size and shape of the bead of compound desired), must be seated properly to ensure a tight and leak-proof connection. This is critical as it directly affects the flow and application of the compound. The tip 104 should be pushed into the base 102 until it is flush, eliminating any gaps that could cause compound leakage.

Placing a Second Connector End Over the Tip and Receiving the Tip in a Cavity of the Second Connector End 1130: This step involves the second connector end 106, which acts as a locking mechanism in accordance with an embodiment. The second connector end 106 in an embodiment has an internal cavity precisely shaped to accommodate the seated tip. The user places this end over the tip 104, aligning it with the base 102. This alignment is crucial as it ensures that the tip 104 is securely held between the base 102 and the second connector end 106.

Tightening a First Set of Threads of the Second Connector End That is Received by a Second Set of Threads in the Base 1140: With the second connector end 106 in place, the user then engages the threads on the second connector end 106 with those on the base 102. By rotating the second connector end 106, typically in a clockwise direction, the threads interlock, pulling the second connector end 106 closer to the base and compressing the tip 104 between them. This action not only secures the tip 104 firmly but also ensures a continuous, leak-proof pathway for the compound.

Loosening the Second Connector End and Removing the Tip to Clean the Base, the Tip, and the Second Connector End 1150: After use, or when a change of tip 104 is required, the second connector end 106 needs to be loosened and removed. This is done by rotating the second connector end 106 in the opposite direction (counterclockwise), which disengages the threads and allows the second connector end 106 to be pulled away from the base 102. The tip 104 can then be removed from the base 102 for cleaning or replacement. This step is essential for maintaining the device's performance and longevity, as it allows for the removal of any residual compound that could clog or damage the device.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A device, comprising:
a first connector end having a first set of threads;
a tip that is configured to be received by the first connector end;
a second connector end having a cavity to receive the tip and tighten the device by connecting a second set of threads with the first set of threads; and
a container of compound that is attached to the first connector end.

2. The device of claim 1, wherein the first connector end comprises a base of the device.

3. The device of claim 1, wherein the second connector end comprises a top of the device.

4. The device of claim 1, wherein the tip comprises a middle layer held flush between the first connector end and the second connector end when the second connector end is tightened into the first connector end.

5. The device of claim 1, wherein the tip comprises a top layer molded to the second connector end which becomes the middle layer when the second connector end is tightened into the first connector end.

6. A device, comprising:
a base;
a customizable tip that sits flush with the base; and
a tightener having a cavity to receive the customizable tip and having a first set of threads that connects with a second set of threads on the base and holds the customizable tip in place.

7. The device of claim 5, wherein the first set of threads sit inside of the second set of threads.

8. The device of claim 5, wherein the first set of threads sit outside of the second set of threads.

9. The device of claim 5, further comprising a container of compound attached to the base.

10. The device of claim 5, wherein the base, the customizable tip, and the tightener are plastic.

11. The device of claim 5, wherein the base, the customizable tip, and the tightener are metal.

12. The device of claim 5, wherein the base, the customizable tip, and the tightener are plant-based.

13. The device of claim 5, wherein the customizable tip is configured to create a bead of compound having a particular size and shape.

14. A method, comprising:
placing a base to receive a tip;
seating the tip in a center of the base;
placing a second connector end over the tip and receiving the tip in a cavity of the second connector end;
tightening a first set of threads of the second connector end that is received by a second set of threads in the base; and
loosening the second connector end and removing the tip to clean the base, the tip, and the second connector end.

15. The method of claim 10, further comprising attaching the base to a container of compound.

16. The method of claim 11, further comprising applying the compound by creating a bead of compound having a particular size and shape that exits from the tip.
